(19) United States
(12) Patent Application Publication
(10) Pub. No.: US 2009/0040189 A1
(43) Pub. Date: Feb. 12, 2009

(54) DISPLAY DEVICE ASSOCIATED WITH TOUCH PANEL, METHOD OF CORRECTING ERRORS OF THE SAME, AND DISPLAY SYSTEM

(76) Inventor: Ki-chan Lee, Cheonan-si (KR)

Correspondence Address: F. CHAU & ASSOCIATES, LLC, 130 WOODBURY ROAD, WOODBURY, NY, 11797, US

(21) Appl. No.: 12/170,814

(22) Filed: Jul. 10, 2008

(30) Foreign Application Priority Data
Aug. 6, 2007 (KR) 10-2007-0078639

(51) Int. Cl. G06F 3/041

(52) U.S. Cl. 345/173

(57) ABSTRACT

A display device associated with a touch panel, a method of correcting errors of the same, and a display system in which the display device includes a pixel unit having pixels for displaying an image, a touch-sensing unit having touch-sensing elements for outputting a touch-sensing signal when the touch-sensing elements are touched and a correcting unit correcting the touch-sensing signal outputted from a first touch-sensing element that has been detected to have failed, a storing unit for storing the coordinate corresponding to the first touch-sensing element, a signal-processing unit for determining whether the first touch-sensing element has been touched by detecting whether a second touch-sensing element corresponding to the coordinate adjacent the coordinate of the first touch-sensing element has been touched.

### CROSS REFERENCE TO RELATED APPLICATION

This application claims priority from Korean Patent Application No. 10-2007-0078639, filed on Aug. 6, 2007, and all the benefits accruing therefrom under 35 U.S.C. §119, the contents of which in its entirety are herein incorporated by reference.

### BACKGROUND OF THE INVENTION

1. Technical Field

The present disclosure relates to a display device associated with a touch panel, a method of correcting errors of the same, and a display system.

2. Discussion of Related Art

The operation of the display device associated with a touch panel is detailed in the following. When the screen of the display device is touched, a common electrode formed on an upper substrate contacts a touch-sensing element formed on a lower substrate, and a predetermined voltage is applied to sensor lines as a touch-sensing signal. The touch-sensing signal is transmitted through the sensor lines, and the position to be touched is detected.

The touch-sensing element may, however, have a short circuit or a disconnection. The short circuit means that the touch-sensing element outputs the touch-sensing signal without being touched. The disconnection means that the touch-sensing element does not output the touch-sensing signal even after being touched. When the short circuit or the disconnection occurs, the display device cannot properly detect the position that is touched, and does not perform correctly.

### BRIEF SUMMARY OF THE INVENTION

Exemplary embodiments of the present invention provide a display device associated with a touch panel capable of correcting errors.

Exemplary embodiments of the present invention also provide a method of correcting errors of the display device associated with a touch panel

Exemplary embodiments of the present invention also provide a display system capable of correcting structural defects.

These and other aspects, features, and advantages of exemplary embodiments of the present invention will be described in or be apparent from the following description of exemplary embodiments.

According to an exemplary embodiment of the present invention, a display device associated with a touch panel including a pixel unit having pixels for displaying an image, a touch-sensing unit having touch-sensing elements for outputting a touch-sensing signal when the touch-sensing elements are touched, and a correcting unit correcting the touch-sensing signal outputted from a first touch-sensing element that is malfunctioning, comprise a storage unit for storing the coordinate corresponding to the first touch-sensing element, a signal-processing unit for determining whether the first touch-sensing element is touched by detecting whether a second touch-sensing element corresponding to the coordinate adjacent to the coordinate of the first touch-sensing element is touched.

According to an exemplary embodiment of the present invention, a method of correcting errors of a display device associated with a touch panel including pixels for displaying an image, and touch-sensing elements for outputting a touch-sensing signal when the touch-sensing elements are touched, includes detecting whether the touch-sensing elements fail and determining whether a first touch-sensing element being detected to have failed is touched by detecting whether a second touch-sensing element adjacent the first touch-sensing element is touched.

According to an exemplary embodiment of the present invention, a display system including a pixel unit having pixels for displaying an image, a touch-sensing unit having touch-sensing elements for outputting a touch-sensing signal when the touch-sensing elements are touched, a driver IC receiving the touch-sensing signal from the touch-sensing unit; and an interface module detecting whether the touch-sensing elements fail, determining whether a first touch-sensing element being detected to have failed is touched by detecting whether a second touch-sensing element adjacent the first touch-sensing element is touched, and outputting the result to a central processing unit.

### BRIEF DESCRIPTION OF THE DRAWINGS

Exemplary embodiments of the present invention will be understood in more detail from the following descriptions taken in conjunction with the attached drawings, in which:

FIG. 1 is a schematic block diagram for explaining a liquid crystal display (LCD) associated with a touch panel according to an exemplary embodiment of the present invention.

FIG. 2 is a schematic diagram for explaining a failure of the touch-sensing element of the LCD associated with the touch panel.

FIG. 3 is a flow chart for explaining part of a method of correcting errors according to an exemplary embodiment of the present invention.

FIG. 4 is a schematic diagram for explaining a part of the method shown in FIG. 3.

FIG. 5 is a sectional view diagram for explaining another part of the method of correcting errors according to an exemplary embodiment of the present invention.

FIG. 6A and FIG. 7A are flow charts explaining another part of the method of correcting errors according to an exemplary embodiment of the present invention.

FIG. 6B and FIG. 7B are schematic diagrams for explaining another part of the method of correcting errors of FIG. 6A and FIG. 7A.

FIG. 8 is a flow chart explaining another part of the method of correcting errors according to an exemplary embodiment of the present invention.

FIG. 9A, FIG. 9B, and FIG. 9C are schematic diagrams for explaining the part of the method of correcting errors shown in FIG. 8.

FIG. 10 is a schematic block diagram for explaining a display system according to an exemplary embodiment of the present invention.

### DETAILED DESCRIPTION OF EXEMPLARY EMBODIMENTS

Advantages and features of the present invention and methods of accomplishing the same may be understood more readily by reference to the following detailed description of exemplary embodiments and the accompanying drawings. The present invention may, however, be embodied in many different forms and should not be construed as being limited to the exemplary embodiments set forth herein. Rather, these exemplary embodiments are provided so that this disclosure will be thorough and complete and will fully convey the concept of the invention to those of ordinary skill in the art, and the present invention will only be defined by the appended claims. Like reference numerals refer to like elements throughout the specification.

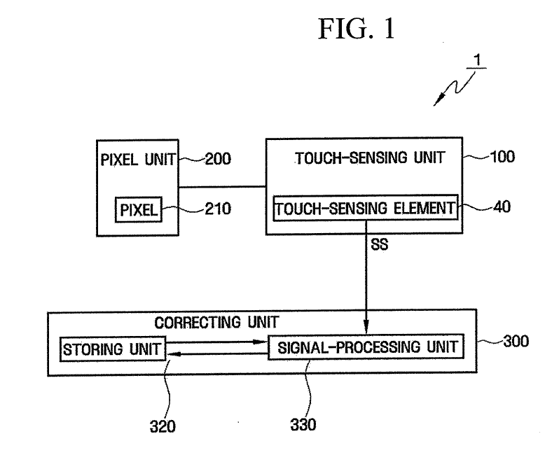

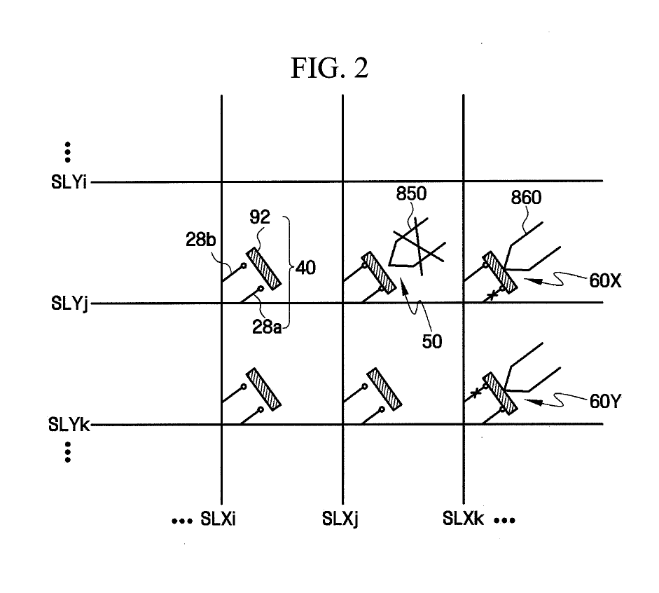

An exemplary embodiment of the LCD associated with a touch panel will now be described with reference to FIGS. 1 and 2. FIG. 1 is a schematic block diagram for explaining an LCD associated with a touch panel according to an exemplary embodiment of the present invention. FIG. 2 is a schematic diagram for explaining a failure of the touch-sensing element of the LCD associated with the touch panel.

Referring to FIG. 1, the LCD associated with the touch panel 1 according to an exemplary embodiment of the present invention includes a pixel unit 200, a touch-sensing unit 100 and a correcting unit 300.

The pixel unit 200 includes pixels 210 for displaying an image. Each of the pixels 210 includes a gate line (not shown), a data line (not shown), and a thin film transistor (TFT) (not shown).

The gate lines and the data lines are arranged in a matrix pattern, gate signals are applied to the each of the gate lines, and data signals are applied to the each of the data lines.

Each of the TFTs is a switching element for transmitting the data signal to the pixel.

The touch-sensing unit 100 is arranged between pixels 210. The touch-sensing unit 100 comprises touch-sensing elements 40 that output a touch-sensing signal SS to sensor lines (see SLXi and SLYk in FIG. 2) when a display device associated with a touch panel 1 is touched.

In this exemplary embodiment, each of the touch-sensing elements 40 may be a contact switch type. Referring FIG. 2, each of the contact-switch-type touch-sensing elements 40 comprises a first sensor electrode 28a, a second sensor electrode 28b and a sensor spacer 92.

The first and second sensor electrode 28a, 28b are formed to protrude from the first and second sensor lines SLXi-SLYk, respectively. Thus, the first and second sensor electrodes 28a, 28b are terminals of the touch-sensing elements 40.

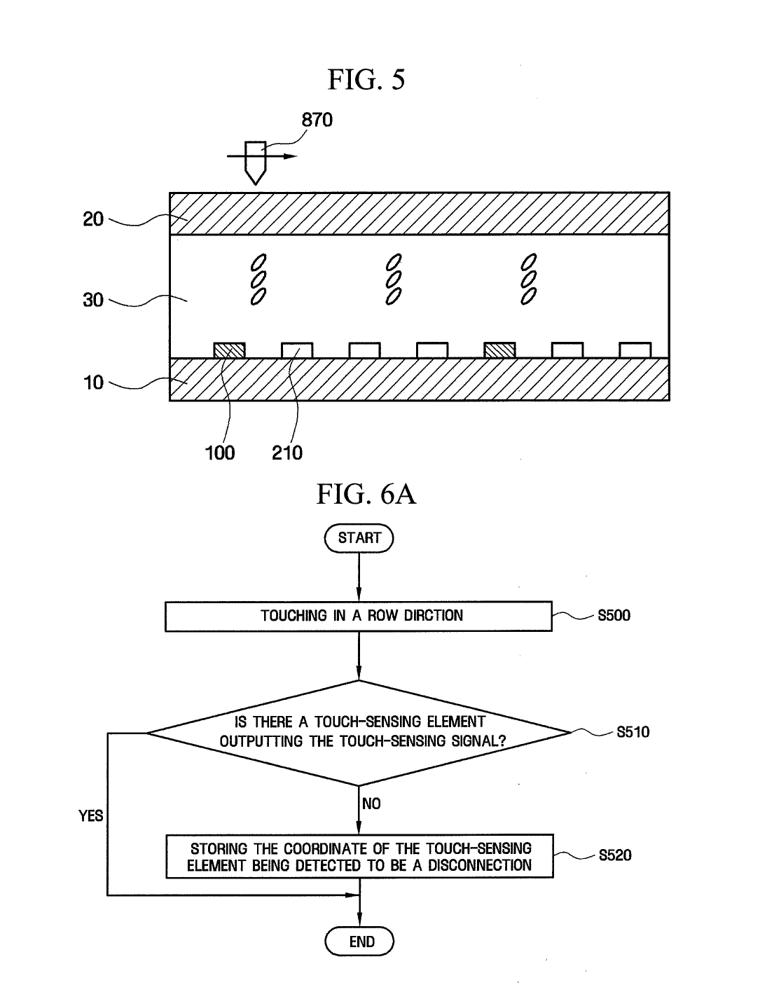

The sensor spacer 92 is formed on an upper substrate (see 20 of FIG. 5). When a screen of the display device 1 is not touched, the sensor spacer 92 is not connected with a lower substrate (see 10 of FIG. 5).

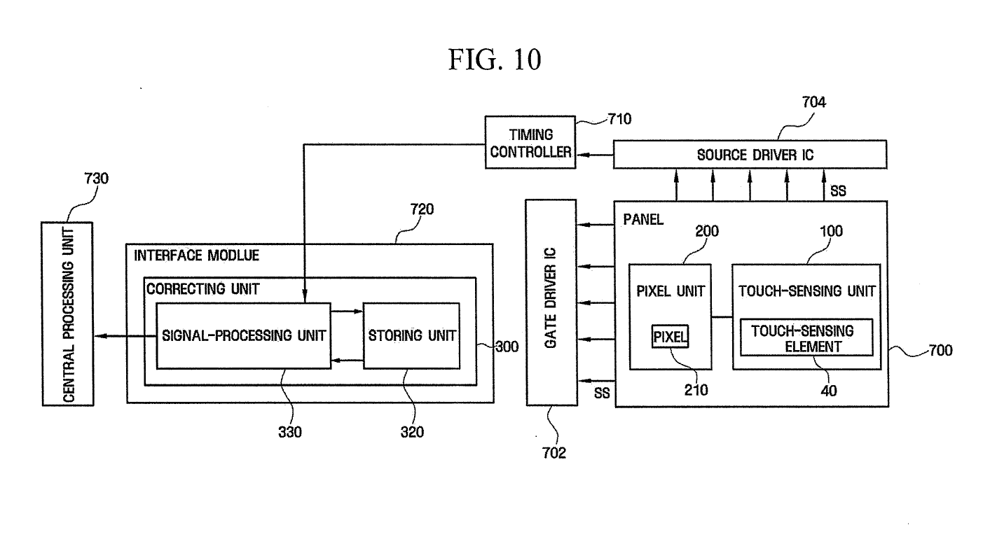

When the screen of the display device 1 is touched, the first and second sensor electrodes 28a, 28b are connected with a common electrode (not shown) on the sensor spacer 92. Then, the touch-sensing signal SS (see FIG. 10) having a predetermined voltage level is applied to the first and second sensor lines SLXi and SLYj, and the touch-sensing signal SS is transmitted through the first and second sensor lines SLXi, and SLYj, and the position being touched is detected.

That is, the first sensor lines SLXi and the first sensor electrode 28a provide the abscissa of the position to be touched and the second sensor lines SLYj and the second sensor electrode 28b provide the ordinate of the position to be touched.

In this exemplary embodiment, the touch-sensing elements 40 may fail. For example, the touch-sensing elements 40 may be a short circuit 50 or a disconnection 60X or 60Y caused by a broken conductor, for example.

The short circuit 50 means the first sensor electrode 28a or the second sensor electrode 28b is connected with the sensor spacer 92 without being touched. Thus, when the short circuit happens, even though the screen of the display device 1 is not touched, the touch-sensing elements 40 output the touch-sensing signal SS.

The disconnection 60X or 60Y means the first sensor electrode 28a or the second sensor electrode 28b is not connected with the sensor spacer 92 after being touched. When the disconnection happens, even though the screen of the display device 1 is touched, the touch-sensing elements 40 do not output the touch-sensing signal SS.

When the short circuit or the disconnection happens, the display device 1 cannot detect the position being touched, and the display device 1 does not work.

Hereinafter, the display device 1 and the method of correcting errors will be described in more detail.

The correcting unit 300 corrects the touch-sensing signal SS (see (FIG. 10) outputted from a touch-sensing element, hereinafter “first touch-sensing element”, that has been detected to have failed. The correcting unit 300 comprises a storing unit 320 and a signal-processing unit 330. The storing unit 320 stores the coordinate corresponding to the first touch-sensing element. The signal-processing unit 330 determines whether the first touch-sensing element is touched by detecting whether a second touch-sensing element adjacent the first touch-sensing element is touched. In this exemplary embodiment, the storing unit 320 may be a nonvolatile memory, such as electrically erasable and programmable read only memory EEPROM.

The operation of the correcting unit 300, the storing unit 320, and the signal-processing unit 330 will be described along with the method of correcting errors.

The method of correcting errors comprises detecting whether the touch-sensing elements fail and determining whether a first touch-sensing element is touched by detecting whether a second touch-sensing element adjacent the first touch-sensing element is touched. In this exemplary embodiment, detecting whether the touch-sensing elements fail may comprise detecting a short circuit and/or a disconnection.

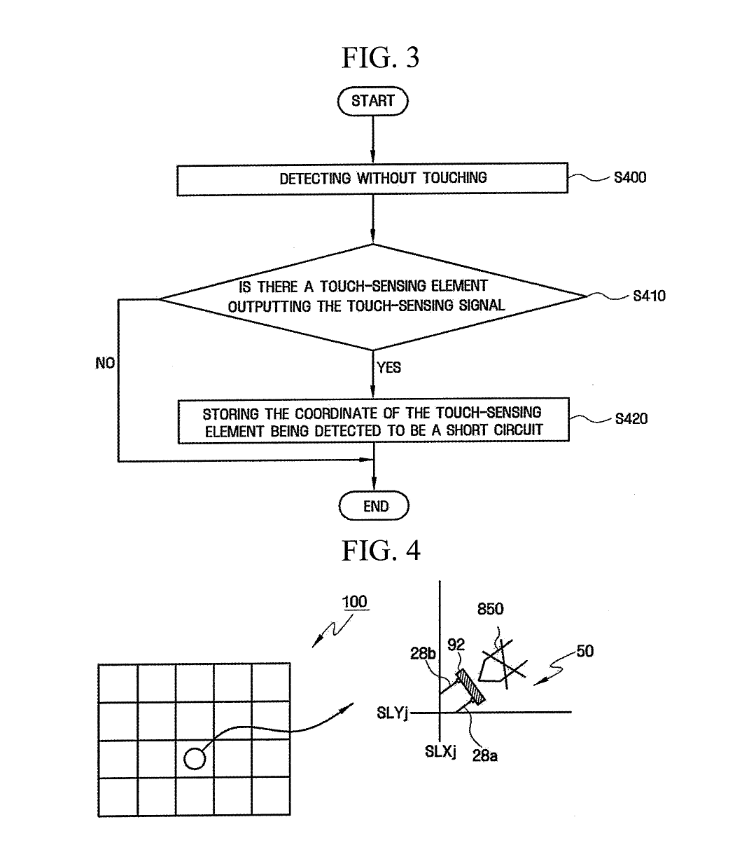

First, the procedure where the correcting unit 300 detects the short circuit and stores the coordinate corresponding to the first touch-sensing element will be described with reference to FIGS. 3 and 4. FIG. 3 is a flow chart for explaining one part of a method of correcting errors according to an exemplary embodiment of the present invention. FIG. 4 is a schematic diagram for explaining the one part of FIG. 3. The circle ◯ in FIG. 4 indicates the coordinate corresponding to the first touch-sensing element.

Referring to FIG. 3, first it is detected whether the touch-sensing element outputs the touch-sensing signal SS without touching S400. The signal-processing unit 330 of FIG. 1 receives the detection result and determines whether the touch-sensing element outputting the touch-sensing signal SS is a short circuit in step S410. The signal-processing unit 330 outputs the coordinate corresponding to the short circuit to the storage unit 320 of FIG. 1. The storage unit 320 stores the coordinate corresponding to the short circuit in Step S420.

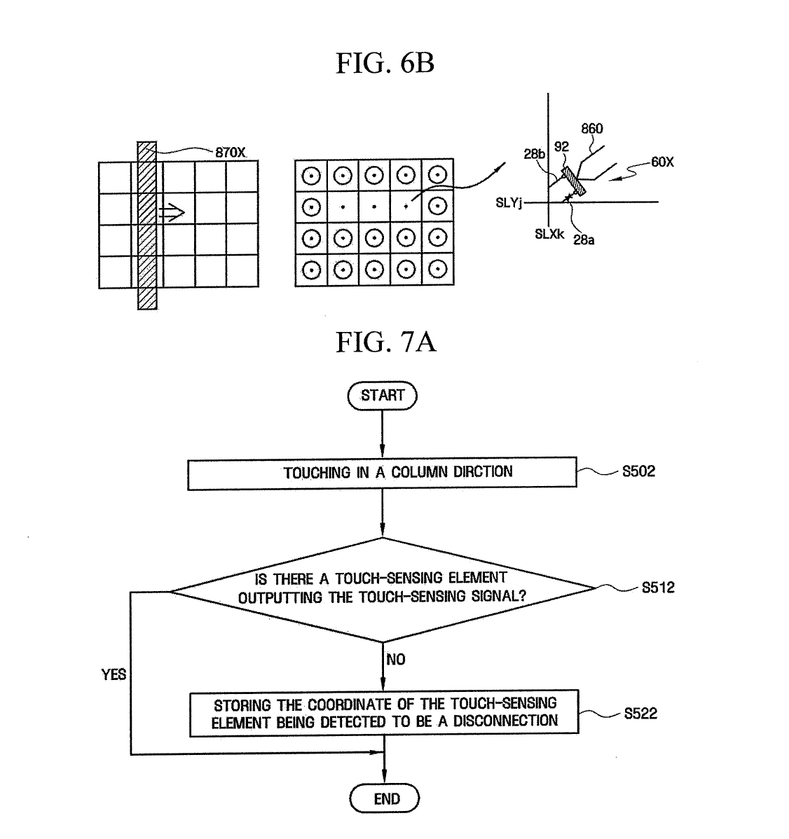

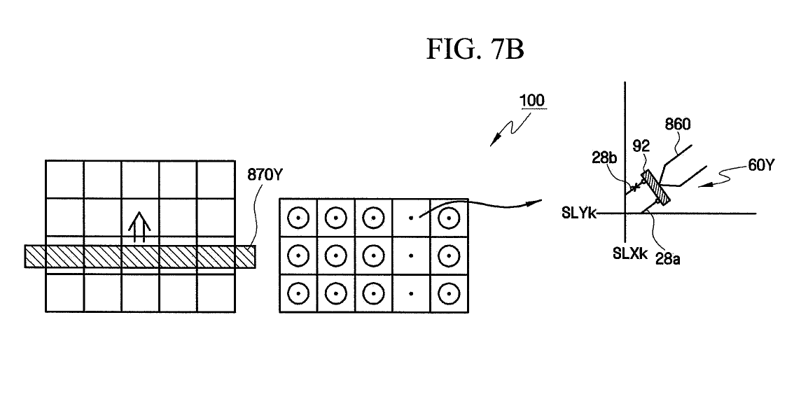

Next, the procedure where the correcting unit 300 of FIG. 1 detects the disconnection and stores the coordinate corresponding to the first touch-sensing element will now be described with reference to FIGS. 5 through 7B. FIG. 5 is a sectional view diagram for explaining another part of the method of correcting errors according to an exemplary embodiment of the present invention. FIG. 6A and FIG. 7A are flow charts explaining that part of the method of correcting errors according to the exemplary embodiment of the present invention. FIG. 6B and FIG. 7B are schematic diagrams for explaining the another part of the method of correcting errors shown in FIG. 6A and FIG. 7A.

Referring to FIG. 5, the screen of the display device is touched by a bar 870 (Step S500). The touch-sensing element is determined to be a disconnection, if the touch-sensing element does not output the touch-sensing signal SS (Steps S510, S520). In this exemplary embodiment, the screen of the display device may be touched by the bar 870 in a row direction and in a column direction.

More specifically, it is detected whether the touch-sensing element outputs the touch-sensing signal SS by touching the screen in a row direction with a X-bar 870X as shown in FIGS. 6A and 6B (Step S500). In this exemplary embodiment, the screen is touched with a predetermined pressure that is more than a critical pressure.

The signal-processing unit 330 of FIG. 1 receives the detection result, and determines that the touch-sensing element not outputting the touch-sensing signal SS is the disconnection S510. When the screen is touched with the X-bar 870X, one more touch-sensing element may operate, because the screen is deformed by the touch with the X-bar 870X. For example, when one point of the screen is touched, at least three touch-sensing elements may output the touch-sensing signals SS, as represented in FIG. 6B. In this case, if at least three touch-sensing elements in a row direction do not output the touch-sensing signals SS, the three touch-sensing elements are determined to be a disconnection.

The signal-processing unit 330 outputs the coordinate corresponding to the touch-sensing element that has been detected to be the disconnection to the storing unit 320. The storing unit 320 stores the coordinate corresponding to the disconnection in Step S520.

Next, it is detected whether the touch-sensing element outputs the touch-sensing signal SS by touching the screen in a column direction with a Y-bar 870Y as shown in FIGS. 7A and 7B (Step S502). The signal-processing unit 330 of FIG. 1 receives the detection result, and determines whether the touch-sensing element not outputting the touch-sensing signal SS is the disconnection (Step S512). The signal-processing unit 330 outputs the coordinate corresponding to the touch-sensing element detected as the disconnection to the storing unit 320. The storing unit 320 stores the coordinate corresponding to the disconnection (Step S522).

Whenever the display device 1 of FIG. 1 is turned on, the detecting of whether the touch-sensing elements have failed, and the storing the coordinate may be performed. That is, power up sequence comprises detecting whether the touch-sensing elements fail and the storing the coordinate so that the detecting and storing procedures may be performed whenever the display device 1 is turned on.

On the other hand, when a manufacturer or a user commands the operation, the detecting of whether the touch-sensing elements have failed, and the storing of the coordinate may be performed.

Otherwise, the detecting of whether the touch-sensing elements have failed, and the storing of the coordinate may be performed automatically and periodically.

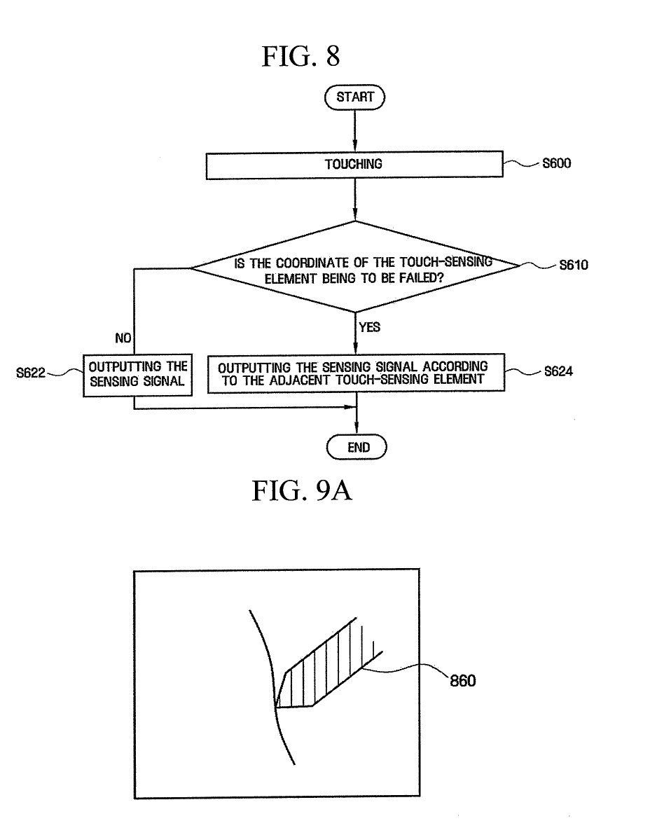

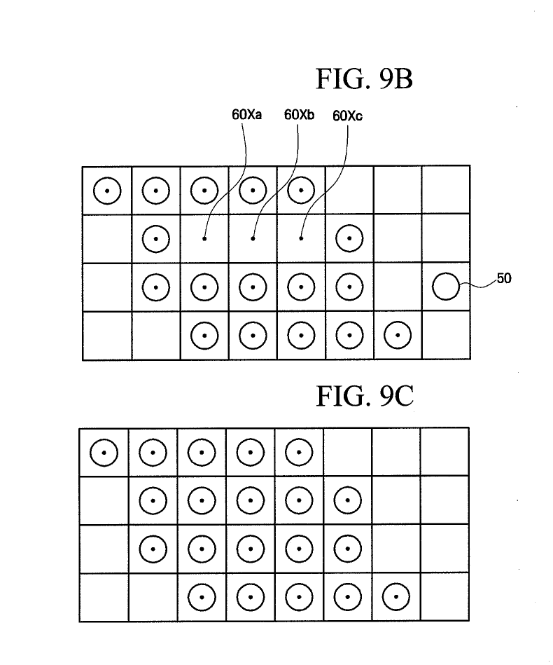

Next, the procedure in which the correcting unit 300 determines whether the first touch-sensing element being detected to havefailed is touched by detecting whether a second touch-sensing element adjacent the first touch-sensing element is touched will be described with reference to FIGS. 8 through 9C. FIG. 8 is a flow chart explaining another part of the method of correcting errors according to an exemplary embodiment of the present invention. FIG. 9A, FIG. 9B, and FIG. 9C are schematic diagrams for explaining the part of the method of correcting errors shown in FIG. 8.

The screen of the display device is touched by a bar 860 as shown in FIG. 9A, and it is detected whether the touch-sensing elements output the touch-sensing signal SS (Step S600).

The signal-processing unit 330 shown in FIG. 1 deals with the touch-sensing signal according to the coordinate corresponding to the touch-sensing element hereinafter referred to as the “third touch-sensing element” (Step S610).

More specifically, if the coordinate corresponding to the third touch-sensing element to output the touch-sensing signal SS is not the coordinate corresponding to the first touch-sensing element, the signal-processing unit 330 outputs the touch-sensing signal SS as it is in Step S622.

If the coordinate corresponding to the third touch-sensing element to output the touch-sensing signal SS is the coordinate of the first touch-sensing element, however, the signal-processing unit 330 deals with the touch-sensing signal SS according to the second touch-sensing elements adjacent the first touch-sensing element in Step S624. That is, if the second touch-sensing elements output the touch-sensing signal SS, the signal-processing unit 330 determines that the third touch-sensing element outputs the touch-sensing signal SS, and if the second touch-sensing elements adjacent the touch-sensing element do not output the touch-sensing signal SS, the signal-processing unit 330 determines that the third touch-sensing element does not output the touch-sensing signal SS.

For example, referring to FIGS. 9B and 9C, regarding the short circuit 50, because the second touch-sensing elements adjacent the third touch-sensing element do not output the touch-sensing signal SS, the signal-processing unit 330 determines that the third touch-sensing elements is not touched. Regarding the disconnections 60Xa, 60Xb, 60Xc, because the second touch-sensing elements adjacent the third touch-sensing element output the touch-sensing signal SS, the signal-processing unit 330 determines that the touch-sensing elements are touched.

Next, the signal-processing unit 330 may output the result to the touch-sensor-interface program, for example, Windows.

A display system according to an exemplary embodiment of the present invention is described with reference to FIG. 10 in the following. FIG. 10 is a schematic block diagram for explaining a display system according to an exemplary embodiment of the present invention.

The display system comprises the pixel unit 200, the touch-sensing unit 100, driver ICs 702, 704, 710, and an interface module 720. Components having the same function as described relative to the embodiment shown in FIG. 1, are respectively identified by the same reference numerals, and their repetitive description will be omitted.

The driver ICs 702, 704, 710 may comprise a gate driver IC 702, a source driver IC 704 and a timing controller 710. The gate driver IC 702 can apply scan signals to the panel, the source driver IC 704 can apply data signals to the panel, and the timing controller 710 can control the gate driver IC 702 and the source driver IC 704.

A sensor-signal detecting circuit (not shown) may be disposed in the gate driver IC 702 and the source driver IC 704. The sensor-signal detecting circuit receives the touch-sensing signal SS from the sensor lines.

The interface module 720 disposed between the driver ICs 702, 704, 710 and a central processing unit 730 deals with the touch-sensing signal SS. The interface module 720 detects whether the touch-sensing elements 40 have failed, determines whether the first touch-sensing element is touched by detecting whether the second touch-sensing element adjacent the first touch-sensing element is touched, and outputs the result to the central processing unit 730.

The interface module 720 may comprise a Micro Controller Unit (not shown). The Micro Controller Unit is a programmable digital electronic component that incorporates the functions of the central processing unit 730 on a single integrated circuit.

The correcting unit 300 may be embodied by the Micro Controller Unit. The correcting unit 300 can comprise the storing unit 320 and the signal-processing unit 330. The storage unit 320 may be embodied by disposing a nonvolatile memory, for example, an EEPROM, in the Micro Controller Unit. Also, the storage unit 320 may be embodied by programming software into the Micro Controller Unit. Otherwise the interface module 720 may be disposed in the timing controller 710.

The central processing unit 730 receives a corrected touch-sensing signal SS from the interface module 720, and controls the display system to deal with information inputted by touching the screen.

Although the present invention has been described in connection with the exemplary embodiments thereof with reference to the accompanying drawings, it will be apparent to those of ordinary skill in the art that various modifications and changes may be made thereto without departing from the scope and spirit of the invention. Therefore, it should be understood that the above exemplary embodiments are not limitative, but illustrative in all aspects.

What is claimed is:

1. A method of correcting errors of a display device associated with a touch panel including pixels for displaying an image and touch-sensing elements for outputting touch-sensing signals when the touch-sensing elements are touched, the method comprising:
detecting whether the touch-sensing elements have failed; and
determining whether a first touch-sensing element detected as failing is touched by detecting whether a second touch-sensing element adjacent to the first touch-sensing element has been touched.

2. The method of claim 1, wherein the detecting whether the touch-sensing elements have failed comprises determining that the touch-sensing element to output the touch-sensing signal is a short circuit when the touch-sensing element has not been touched.

3. The method of claim 1, wherein the detecting whether the touch-sensing elements have failed comprises touching a screen of the display device and determining that the touch-sensing element that does not output the touch-sensing signal is a disconnection when the touch-sensing element is touched.

4. The method of claim 3, wherein the touching of the screen of the display device comprises touching the screen in a row direction of the pixels and touching the screen in a column direction of the pixels.

5. The method of claim 1, wherein the determining whether the first touch-sensing element is touched comprises storing a coordinate of the first touch-sensing element.

6. The method of claim 1, wherein the determining whether the first touch-sensing element is touched comprises storing a coordinate of the first touch-sensing element in a storing unit, and detecting whether the second touch-sensing element corresponding to a coordinate adjacent the coordinate of the first touch-sensing element is touched.

7. The method of claim 6, wherein the detecting whether the touch-sensing elements have failed is performed at one of when the display device is turned on, when a command is input, and periodically.

8. The method of claim 6, wherein the storing unit is a nonvolatile memory.

9. The method of claim 8, wherein the nonvolatile memory is an EEPROM.

10. A display device associated with a touch panel, comprising:
a pixel unit having pixels for displaying an image;
a touch-sensing unit having touch-sensing elements for outputting respective touch-sensing signals when the touch-sensing elements are touched; and
a correcting unit correcting the touch-sensing signal outputted from a first touch-sensing element being detected to have failed, comprising a storage unit for storing a coordinate corresponding to the first touch-sensing element, a signal-processing unit for determining whether the first touch-sensing element is touched by detecting whether a second touch-sensing element corresponding to a coordinate adjacent the coordinate of the first touch-sensing element has been touched.

11. The display device of claim 10, wherein the touch-sensing elements are each a contact switch type.

12. The display device of claim 10, wherein the storing unit comprises a nonvolatile memory.

13. The display device of claim 12, wherein the nonvolatile memory comprises an EEPROM.

14. A display system comprising:
a pixel unit having pixels for displaying an image;
a touch-sensing unit having touch-sensing elements for outputting a respective touch-sensing signal when the touch-sensing elements are touched;
a driver IC receiving the touch-sensing signal from the touch-sensing unit; and
a interface module detecting whether the touch-sensing elements have failed, determining whether a first touch-sensing element being detected to have failed is touched by detecting whether a second touch-sensing element adjacent the first touch-sensing element is touched, and outputting a result to a central processing unit.

15. The display system of claim 14, wherein the interface module comprises a correcting unit correcting the touch-sensing signal outputted from the first touch-sensing element, and wherein the correcting unit comprises a storing unit for storing a coordinate corresponding to the first touch-sensing element.

16. The display system of claim 15, wherein the correcting unit further comprises a signal-processing unit for determining whether the first touch-sensing element is touched by detecting whether a second touch-sensing element corresponding to a coordinate adjacent the coordinate of the first touch-sensing element has been touched.

17. The display system of claim 15, wherein the storing unit comprises a nonvolatile memory.

18. The display system of claim 17, wherein the nonvolatile memory comprises an EEPROM.
